(19) United States
(12) Patent Application Publication
(10) Pub. No.: US 2014/0304182 A1
(43) Pub. Date: Oct. 9, 2014

(54) BADGE LOGICAL GROUPIING ACCORDING TO SKILLS AND TRAINING

(71) Applicant: Microsoft Corporation, Redmond, WA (US)

(72) Inventors: T. Varugis Kurien, Redmond, WA (US); Donald Frank Brinkman, Seattle, WA (US); Vinay Balasubramaniam, Redmond, WA (US); Suyash Sinha, Redmond, WA (US); Alpesh R. Gaglani, Bellevue, WA (US); Tushar Subodh Nene, Sammamish, WA (US)

(21) Appl. No.: 13/925,630

(22) Filed: Jun. 24, 2013

Related U.S. Application Data
(60) Provisional application No. 61/809,112, filed on Apr. 5, 2013.

(51) Int. Cl. G06Q 10/10

(52) U.S. Cl. CPC G06Q 10/1053
USPC 705/321

(57) ABSTRACT

Identifying that one or more badges in a set of a plurality of badges indicates that an individual having the set of a plurality of badges meets certain requirements in terms of one or more of skills, training, attributes, or qualifications. The method includes identifying a set of a plurality of badges for an individual. The method further includes identifying evaluation criteria, the evaluation criteria comprising criteria for evaluating a plurality of badges, that when satisfied, indicates that an individual meets certain requirements. The method further includes comparing the set of the plurality of badges to the evaluation criteria. Based on comparing the set of the plurality of badges to the evaluation criteria, the method further includes determining whether or not the individual meets the certain requirements

### CROSS-REFERENCE TO RELATED APPLICATIONS

This application claims the benefit of U.S. Provisional application 61/809,112 filed Apr. 5, 2013, titled “TRUSTWORTHY CREDENTIALING SYSTEMS”, which is incorporated herein by reference in its entirety.

### BACKGROUND

### Background and Relevant Art

So called “badges” are digital credentials representing skills, training, attributes, or qualifications of an individual. Credentialing systems, like the Open Badges Framework as currently defined, are open to spoofing attacks. Given that a badge may be a PNG image that contains a reference to a remote site that verifies the badge (i.e. reviewer/interviewer), an attacker can easily copy the PNG of an existing trustworthy badge that is issued by a trustworthy organization and spoof a reviewer/interviewer of the credential or use this as the basis of an attack on the reviewer/interviewer.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for identifying that one or more badges in a set of a plurality of badges indicates that an individual having the set of a plurality of badges meets certain requirements in terms of one or more of skills, training, attributes, or qualifications. The method includes identifying a set of a plurality of badges for an individual. The method further includes identifying evaluation criteria, the evaluation criteria comprising criteria for evaluating a plurality of badges, that when satisfied, indicates that an individual meets certain requirements. The method further includes comparing the set of the plurality of badges to the evaluation criteria. Based on comparing the set of the plurality of badges to the evaluation criteria, the method further includes determining whether or not the individual meets the certain requirements.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a badge verification scenario;

FIG. 2 illustrates using a tablet to superimpose an indicator on a badge;

FIG. 3 illustrates a badge subscription scenario;

FIG. 4 illustrates a method of authenticating badges;

FIG. 5 illustrates a method of identifying that one or more badges in a set of a plurality of badges indicates that an individual having the set of a plurality of badges meets certain requirements in terms of one or more of skills, training, attributes, or qualifications; and

FIG. 6 illustrates a method of sending alerts regarding events related to badges.

### DETAILED DESCRIPTION

Various embodiments may be implemented. For example, embodiments may include a mechanism by which credentials (such as badges) issued by issuers certifying skills, training, attributes, and/or qualifications that can be verified by using cryptographic protocols or other policy evaluations. In alternative or additional embodiments, a set of mechanisms may be implemented by which trustworthiness of credentials can be made apparent to third parties viewing the credential for the purpose of assessing the skills, training, attributes, and/or qualifications of users who have been issued the credentials.

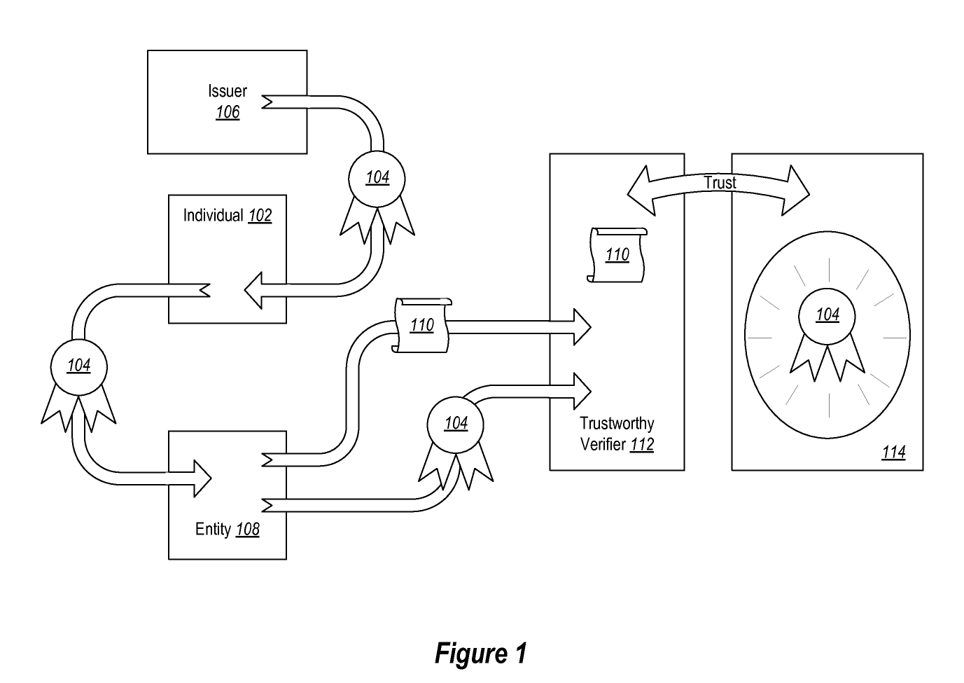

Referring now to FIG. 1, an example is illustrated. In the example illustrated in FIG. 1, an individual 102 desires to obtain a badge 104 that signifies certain skills, training, attributes, and/or qualifications possessed by the individual 102. To accomplish this, the individual 102 demonstrates to an issuer 106 that they possess the certain skills, training, attributes, and/or qualifications. This may be performed by taking a test, demonstrating a certain skill, providing certification from a third party, or in any of a number of different ways.

Based on the individual 102 demonstrating to the issuer 106 that they possess the certain skills, training, attributes, and/or qualifications, the issuer 106 issues a badge 104 to the individual 102. The individual 102 can then present the badge 104 to different entities to demonstrate to the different entities that they have the certain skills, training, attributes, and/or qualifications.

For example, as illustrated in FIG. 1, the individual 102 can present the badge to the entity 108 to indicate to the entity 108 that the individual has certain skills, training, attributes, and/or qualifications. However, as noted, some unscrupulous individuals may fabricate badges by using valid badges issued to other individuals and substituting in their own identification to make the badges appear as if they belonged to the unscrupulous individual. In particular, given that the badge is typically simply an image that identifies the badge, the issuer and the recipient of the badge, an unscrupulous user may individual may modify the image to remove the valid recipient information and substitute in their own information. Thus, the entity 108 may desire to have the badge 104 verified to ensure that it is a valid badge for the individual 102 that provided the badge to the entity 108.

The entity 108 may have certain criteria that it would like satisfied regarding the badge 104. For example, the entity 108 may have certain criteria that need to be satisfied for the badge to be considered authentic by the entity 108. Illustratively, the entity 108 may desire that the badge be issued by a limited set of certain issuers and that the badge is signed by a trusted certificate authority. The criteria may be specified in a policy 110. The policy 110 can be identified to, or provided to a trustworthy verifier 112. Additionally, the badge 104 may be identified to, or provided to the trustworthy verifier 112. The trustworthy verifier 112 is trustworthy only insofar as it faithfully executes the policy 110. The trustworthy verifier 112 does not execute any default policy outside of the policy 110 on behalf of the specified relying party who asks the verifier about whether a specified badge satisfies the policy 110. The trustworthy verifier 112 can use the policy 110 to determine if the badge 104 is meets certain criteria specified in the policy 110. If the badge 104 meets criteria specified in the policy 110, the badge is displayed by a displayer 114 (that has a trust relationship with the trustworthy verifier 112) to the entity 108 in a trustworthy way. In this way, the entity 108 knows that the badge is authentic and/or meets other various criteria. As such, the entity 108 can verify that the individual 102 possess the certain skills, training, attributes, and/or qualifications signified by the badge in a fashion approved of by the entity 108.

Additional details are now illustrated. Within the Open Badges framework, a badge is stored in a virtual directory called a backpack. In some embodiments, rather than providing cryptographic protection of an individual badge that can be verified, embodiments may provide cryptographic protection of a backpack such that any badge in the backpack can be verified by verifying the cryptographic protection of the backpack. A backpack can be conceptualized as a container that specifies a set of rules around what badges are allowed to be added to it. Cryptographically this can be represented as a group that is defined by a set of claims across attributes of the root certificate that defines the group and other claims of the issuer identified by the certificate. Trust is then in the backpack.

In some embodiment a backpack formed on the basis of an (extended validation) EV cert tree(s) that may be used (while other embodiments may use other certification or security measures). The use of EV certificates has the advantage that code in modern browsers that display a green navigation bar already exists and can be re-purposed to perform trustworthy displays of badges. However, embodiments may be extended to resolve some known problems that EV certificates have. For example, some embodiments that build a backpack may specify not only an EV check but also perform an online check against a remote entity that acted as a revocation store to flush known bad EV certifiers (essentially a form of CRL that can be implemented, for example, as an online certificate status protocol (OCSP) provider in Microsoft® Windows available from Microsoft® Corporation of Redmond Wash.).

This gives the issuer of the backpack the ability to control the criteria for admittance into the backpack. Note that in this model, a badge is just a claim issued by a security token service (STS). Some embodiments may use a backpack as the base unit in the security protocol as it is easier for users to ascertain trustworthiness of a backpack rather than an individual badge. In effect if the backpack is treated as a directory, the directory is protected by a cryptographic ACL that protects an appended permission on the backpack. Backpacks or badges that have been secured in this way may be referred to as trustworthy backpacks/badges herein.

The following now illustrates cryptographic protection of badge groupings. Backpacks possess an additional capacity to assign badges to groups for the purposes of displaying and maintaining a collection of badges within particular contexts. Groups are subsets of the set of all badges in the backpack but do not necessarily form a partition of the set of all badges. One or more badges may belong to multiple groups or to no group at all. If one thinks of the backpack as a directory that contains all badges, the groups are folders within that directory that contain symbolic links to the badges in the parent directory. Such a relationship is non-commutative in the sense that while it is trivial to determine the badges that belong to a particular group, the opposite does not hold. In considering security, consideration is given to the rights granted to backpacks, groups, and individual badges.

Optionally, the backpack may have rules that specify to which parties the backpack may be disclosed. This is so that organizations have the ability to inform users that they do not approve of the entity to which the user has decided to divulge a badge. That is, the backpack can have a read ACL that is cryptographically specified. These protections can extend to groups and to individual badges. Some embodiments may define rules such that only particular badges within the backpack are restricted or to restrict groups based on the badges that they contain.

Embodiments may implement displayers. A browser, or other security enforcing element, engages in a user-security protocol that allows a user to verify that they are not seeing a spoofed backpack/badge or group/badge. Thus, embodiments implement a UI element referred to herein as a displayer. The displayer can display elements like backpacks, groups or individual badges. The displayer can be conceptualized as a directory browser with spoofing resistance features. The displayer uses secure meta-information (e.g. signed objects) from the badge, group or backpack to display.

The following illustrates an example implementation of the displayer in a web browser. The displayer when interacted with using an explicit user action, can display the cryptographic information for the EV certificate in the browser address bar. This implementation re-uses existing code in modern web browsers that turns the address bar green when a site has an EV certification.

The following illustrates an example implementation of the displayer in client-side applications. An email or word processing application can parse PNG image files to identify images that contain badge information. These images can then be displayed in a secure container that can indicate the validity of the badge. Invalid badges will not be displayed in the container.

Some embodiments may implement a more secure implementation. Some embodiments of the system as defined above may be subject to an overlay attack. For example, the element being viewed as a valid badge might actually be a composited view of two images, one trustworthy and the other not. The interaction verifies the trustworthy object but the untrustworthy objects effectively hijacks this check to show the untrustworthy component. A more secure implementation may be implemented which sends the document to the trustworthy verifier 112 that would display only the secured parts of the content as a facsimile. The trustworthy verifier 112 can be a trusted web site or other entity and embodiments can use EV (or other certifications) to gain initial trust in the trustworthy verifier 112.

Generalizations: This is a specific implementation of the following security principle: The viewer (e.g. a browser) has a secure display area (e.g. an address bar) that is isolated from a normal user running in the viewer. The identity of an element (e.g. trustworthy backpack/group/badge) that is undergoing an explicit interaction with the user can be verified using cryptographic protocols defined above and the result of this is displayed in the isolated area (e.g. the address bar). If a displayer (such as piece of paper in the example above) is spoof resistant (since the piece of paper is received through an out of band and trustworthy process) the process above can be generalized to other entities as follows: The displayer only accepts elements on the trustworthy display from trustworthy entities. The displayer does not display any content whose trustworthiness it cannot verify.

For example, the trustworthy displayer may be an application that is downloaded from a trustworthy source (e.g. Microsoft®/Mozilla Foundation/etc.) and renders the html of a page that is pointed to by a human verifier after filtering out untrustworthy elements defined by external metadata (like the identity of a badge issuer). The displayer is assumed to run in a different security boundary from the display (e.g. in the browser), such as in one example, through OS based isolation mechanisms such as Virtual Accounts or Mandatory Integrity Control In Microsoft® Windows—which are already integrated into browsers such as Internet Explorer® available from Microsoft® Corporation of Redmond Wash.

Displaying badges in a trustworthy way can be accomplished in any of a number of different fashions. For example, in some embodiments, the trustworthy verifier 112 may provide a secure web page to the entity 108 that only displays verified badges that have been verified according to the policy 110 identified or provided by the entity 108. Alternatively badges not meeting policy may be displayed, but they may be displayed with a clear indication of, for example, inauthenticity, such as a red X being overlaid on the badge.

Additionally or alternatively, the trustworthy verifier 112 may provide a report about badges submitted to it. The report can identify policy compliant badges and/or badges that do not comply with policy. The report may further specify which policy checks that a particular badge did not comply with, which caused the badge to be declared non-compliant with the policy.

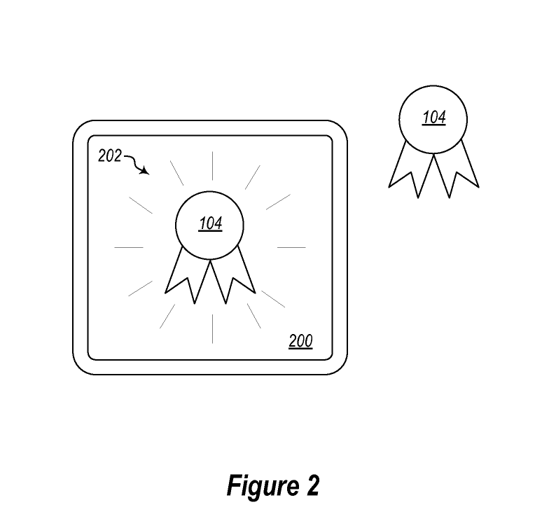

Additionally or alternatively, embodiments may provide for an overlay to be superimposed on a badge to indicate its compliance with policy or non-compliance with policy. For example, as shown in FIG. 2, a user may use a tablet device 200 having a camera to authenticate badges. The user can point the camera of the tablet device 200 at a badge 104. The tablet device 200 can connect to the trustworthy verifier 112 and transmit an image of the badge 104 to the trustworthy verifier 112. The trustworthy verifier can indicate that the badge is compliant with the policy. The tablet device 100 can then display the badge with an indication of compliance with policy, such as a green halo 202 or other indication. When a badge is determined to be non-compliant with the policy, the tablet device 200 could display the badge with a red halo, red X or other indication indicating that the badge is non-compliant with the policy. Similar embodiments may project indicators onto physical facsimiles of badges. For example, a user wearing specialized glasses having a camera that takes images of the badge and network hardware to upload images of the badge may also have a projector, such as a heads up display projector or projector that is able to project directly onto a badge facsimile. An indicator can be projected onto a physical facsimile of a badge indicating whether or not the badge is compliant with the policy. Illustratively, a hiring manager using such devices could quickly evaluate resumes having badges printed on them by using the tablet device or projection hardware.

The following illustrates a fiction example of a badge verification scenario. In the following example, the following cast of characters are used to demonstrate the principles:

GreatCompany: An open badge issuer that has an established market brand.

Badgemill: An open badge issuer that has no established presence at all but seeks to mint badges that masquerade as those issued by GreatCompany.com.

Polonius: An unethical consumer of badges from Badgemill.com as well as other open badge issuers.

Gertrude: A person who has a badge from GreatCompany.

Fortinbras: A hiring manager.

Trustworthy Open Badge Verifier: A service that evaluates an expression called a badge limit expression (e.g. a policy).

When Fortinbras looks at Gertrude and Polonius's on-line profile pages, he sees what he thinks are valid open badges issued by GreatCompany. Being of a skeptical turn of mind, Fortinbras sends the links of both Gertrude and Polonius's profiles to the Trustworthy Open Badge Verifier who then verifies that the previously configured badge limit expression created by Fortinbras is verified. Fortinbras has configured the Trustworthy Open Badge Verifier with the following badge limit expression (for Fortinbras):
Badge must be signed using an EV certificate that was validly time stamped at the time of signing;
The EV certificate must be issued by a trustworthy CA in the Better CA list (URI); and
The Issuer CN is found in a list of companies at Trustworthytech (itself protected by an EV certificate in the Better CA list).

The Trustworthy Open Badge Verifier accesses both Gertrude and Polonius's page and downloads the content; extracts all PNGs and identifies any badges; retrieves the assertions of each; filters out all badges that do not fit the criteria imposed by Fortinbras in the badge limit expression; and, a Displayer, which only displays badges that it receives from trusted Verifiers prints out a PDF of both Gertrude and Polonius's pages. Since Polonius's badge failed the conditions evaluated by TOBI, the Displayer chooses to display Polonius's page with big red X's through all of Polonius's badges that did not satisfy the expression.

Note what happened here: a verifier filtered out all badges not satisfying a policy defined by the limit expression; in this case, the Displayer implicitly only displayed the badges defied by the above limit expression; and since the trustworthiness of the Displayer is accepted as face value (itself verified by an EV certificate), the user only has to acquire trust in the Trustworthy Open Badge Verifier and Displayer since he believes that the Trustworthy Open Badge Verifier faithfully enforces his policy and that the Displayer only displays badges that it receives from trusted Verifiers. The Displayer and the Trustworthy Open Badge Verifier may establish this trust by an out of band means, such as a certificate or key exchange, or other credentialing process.

There are some challenges created by the distributed nature of an open architecture: For example, the Open Badges framework is a designed to be distributed and platform-agnostic. As such it is possible for there to be a multiplicity of issuers, backpacks, and displayers. This invites challenges such as how to reconcile the case where an issuer uses one backpack but the badge earner uses another. Embodiments may remedy this situation by using a federation that relies on a trust relationship between backpacks so that an issuer/earner/displayer can access the sum of badges from any single entry point. The federation can be shallow or deep. For example, in a shallow federation, in effect the different backpacks can simply communicate and relay information from other backpacks. Fore a deep federation, deep copies of all information can be performed to synchronize backpacks. Deep federation has the advantage of making the system more resistant to temporary or permanent loss of backpacks in the federation but brings with it new challenges such as the risk that malicious badges created by an untrusted backpack might be replicated to a trusted backpack and thus earn undeserved trust. These risks can be mitigated using strategies similar to those already applied to CAs as well as extensions similar to those described herein.

Embodiments may use additional metadata to implement virtual groupings of badges. If the displayer preprocesses the complete set of badges in a backpack or group, embodiments may create virtual groupings based on results of cryptographic checks. For example, a container may only show verified badges, group badges into virtual groups for verified and unverified, and/or group badges according to the certificate authority (CA) and/or issuer. Such virtual grouping provide additional information for the user (e.g. the entity 108) and make it easier for the user to understand the gestalt trustworthiness of the collection of badges. Additional metadata can be shown on a badge-by-badge basis according to compliance of badges to particular rules and policies set by a backpack, CA or issuer. This metadata may appear as colors, text, images, etc. to indicate qualities such as ‘difficulty’, ‘scope’, ‘age’, ‘reputation’ and/or other quantitative and qualitative values. Note that when the metadata for a badge is signed by a signing key, the metadata is also verified by the signature and consequently the groups themselves can be cryptographically verified by a displayer.

Some embodiments may implement backpack limiting badge acceptance by issuer. In previous systems a backpack did not distinguish between issuers issuing badges. Rather, if either a user uploaded, or an issuer forwarded a badge to the backpack, the backpack would accept it. Embodiments herein may be extended to allow a backpack service to limit whether badges are imported into a backpack or not. For example, embodiments may give the backpack service owner the ability to limit which badges can be stored in the backpack. This may be done in some embodiments by defining an expression referred to herein as a basic limit expression. A limit expressions may be defined using include various parameters to allow or disallow badges based on the parameters. Such parameters may include: an issuer URL; issuer certificate parameters (whether or not badge is signed), including but not restricted to the certificate owners common name, email address, locality, thumbprint, etc.; badge assertion type (signed vs. non-signed); a combination of issuer certificate attributes and expressions including but not limited to:
Asssertion.badge.issuer.*
Asssertion.badge.criteria
Assertion.badge.issued_on
Asssertion.badge.expires
Etc.

The limit expression will be appropriately normalized and hashed so as to be able to verify the integrity of the limit expression under various integrity protection schemes, such as signing or HMAC'ing. Thus, the limit expression can itself be protected by a signature.

Such functionality will give the backpack service owner the ability to have multiple rules defined. Additionally or alternatively, this may give the backpack service owner the ability to also create “blacklist” rules.

Embodiments may include functionality to allow limit expression rules to be able to be applied at later dates.

Embodiments may also include functionality for handling cases where, because of limit expressions rules, badges that were once accepted now are not. In such cases, the badge owner can be notified and the badge “hidden” from being shared.

Embodiments may further include functionality to allow a user to be able to “layer on” additional limiting rules on top of the backpack service owner. However, some embodiments are implement such that a user cannot override the settings of the service owner.

Embodiments may include functionality for allowing user defined ACL's for allowing Displayer's to access groups. While in previous systems, either a badge group was public or not, some embodiments described herein allow badge groups to have finer grained access. For example, a user can specify that a group of badges are viewable by any displayer, a list of displayers (white list), or all but a list of displayers (black list).

For example, embodiment may give the user the ability to limit which group of badges can be accessed by which Displayer by selecting various options. For example, a user may be able to specify Displayers in a white list allowing access to only those Displayers enumerated in the white list. Alternatively, a user may be able to specify Displayers in a black list, which allows all Displayers except those in the black list to display badges or groups of badges. Alternatively, a user may be able to specify that access is public, meaning any Displayer can display badges or groups of badges for the user.

However, the backpack service owner may be able to limit which Displayer's have access to any of the groups hosted by the backpack. Further, in some embodiments, the user does not have the ability to override the service owner. That is, a displayer is not allowed by the service owner, the user cannot then share a group with that displayer.

Embodiments may support issuer defined badge grouping. An issuer can “publish” badge group rules. A backpack can query for these groups from the issuer. The backpack can create and alter membership to badge groups automatically based on these rules. The backpack can periodically check/re-group badges to handle changes to the rules from the Issuer (including having one or more rules be removed, invalidated and/or retired). Displayers can display these new groups. Further, Displayers may able to validate the rules from the Issuer prior to displaying.

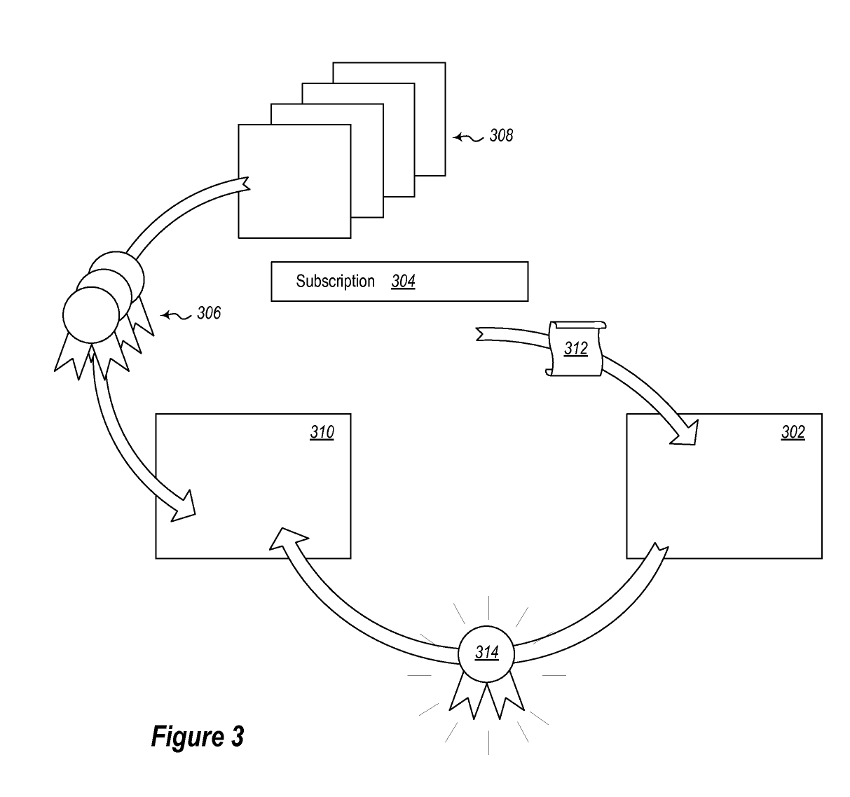

In addition to virtual groupings, the system defined above can be used to generalize badge issuances. A common problem in badging infrastructures is that of how badges grouped together for the purposes of display or further badge issuance. For example, a group of badges that relate to a particular dimension (skill set) may be grouped together for the purposes of display or to issue a “super badge” representing a collection of badges. For example, as illustrated in FIG. 3, an issuer 302 registers interest with a subscription service 304 in receiving updates for a specified set of badges 306 from possibly other issuers 308 to an individual 310. The issuer 302 then consumes the badge metadata 312 and if certain issuance conditions are met on the metadata 312, the issuer 302 can issue another badge 314 and binds the collection of badges 306 that it used to issue the dependent credential to the originating credentials.

Illustratively, a limit expression can be used recursively in an event driven system to cause issuance of new badges when presented with a bag of badges. For example, an assertion badge criteria may contain a limit expression and identify a bag of badges used to mint a new badge. A Verifier can re-evaluate the limit expression and check to see if the expression is still valid. This allows for the issuance of super badges made out of smaller badges and represents smaller achievements building up to a larger whole.

This mechanism can be used to provide the notion of a “skill trajectory” where a sequence of badges collapse into a higher value credential. The difference between normal means used in the industry and embodiments herein is that the condition under which the dependent badges are issued is cryptographically defined and verifiable—hence trustworthy.

Alternatively, an entity such as an issuer/hiring entity may want to register with a subscription service 304 for notifications of changes to an individual's badge set. When an individual has obtained a certain badge or certain set of badges, the individual may be of interest to a hiring entity. Consider the following scenario:

A headhunter is looking for candidates who have specified skills. They create a limit expression in a badge space (such as by subscribing to the subscription service 304) and bind trust to one or more verifiers (such as the trustworthy verifier 112 illustrated in FIG. 1). The subscription service 304 listens for updates to users badge information and filters out those that meet the expression. The headhunter receives events, such as the badge metadata 312 when expressions are satisfied.

A subscription model as illustrated in FIG. 3 can be used for various purposes such as those illustrated above in the issuance of super badges or notifications to interested parties (such as the headhunter) when badges are obtained. However, it should be appreciated that subscriptions and alerts may be used for a number of various purposes. For example, alerts can be sent to notify when badges are about to expire. Alerts can be sent to notify an individual of badges that could be earned that are related to badges already obtained by the individual. Alerts can be sent to notify an individual of badges that could be earned that are related to badges already obtained by the individual to complete requirements for a super badge. Etc.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

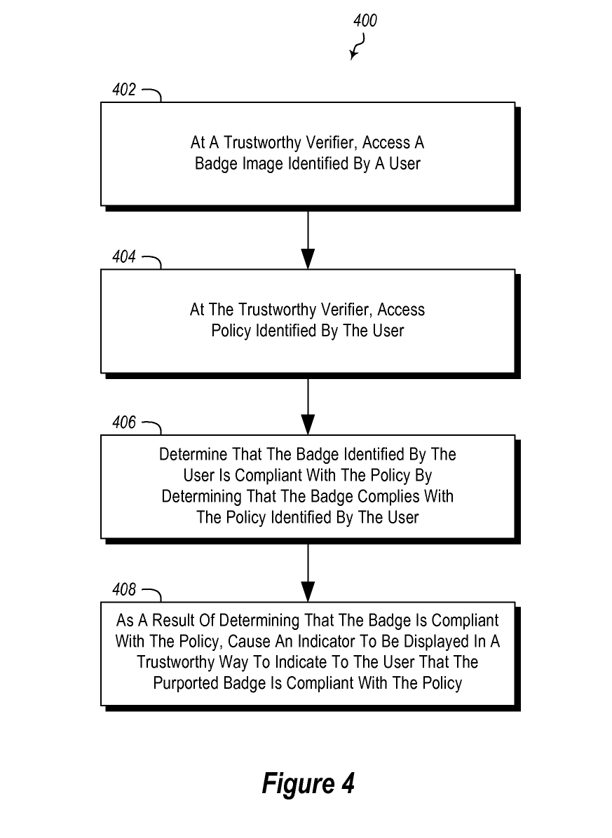

Referring now to FIG. 4, a method 400 is illustrated. The method 400 may be practiced in a computing environment and includes acts for authenticating a badge. The badge represents at least one of skills, training, attributes, or qualifications of an individual. The method 400 includes at a trustworthy verifier, accessing a badge image identified by a user (act 402). For example, as illustrated in FIG. 1, the badge 104 can be accessed by the trustworthy verifier 112. This may occur in a number of different ways. For example, an image of the badge may be sent to the trustworthy verifier. Alternatively, a link where the badge can be obtained may be sent to the trustworthy verifier, where the trustworthy verifier can obtain the badge itself.

The method 400 further includes, at the trustworthy verifier, accessing policy identified by the user (act 404). For example, as illustrated in FIG. 1, policy 110 may be identified and accessed by the trustworthy verifier 112.

The method 400 further includes determining that the badge identified by the user is compliant with the policy by determining that the badge complies with the policy identified by the user (act 406). As illustrated in FIG. 1, the trustworthy verifier may be able to perform this comparison. As example, the policy may indicate one or more of certain signatures on the badge, certain signers of the badge, certain issuers of the badge, certain issue times and/or expirations of the badge, or any of a number of other criteria.

The method 400 further includes, as a result of determining that the badge is compliant with the policy, causing an indicator to be displayed in a trustworthy way to indicate to the user that the purported badge is compliant with the policy (act 408). For example, the trustworthy verifier may cause the displayer 114 to display the badge. Note that the displayer is a trustworthy displayer. The displayer 114 may also have an out of band trust established with the trustworthy verifier 112.

The method 400 may further include determining that one or more other badges identified by a user are not compliant with the policy based on the one or more other badges not complying with the policy identified by the user, and as a result not displaying the one or more other badges. In particular, in some embodiments, badges may be prevented from being displayed when they do not comply with the policy.

The method 400 may further include providing a report that indicates badges that are compliant with the policy and provides information about why badges that are non-compliant with the policy failed the policy. Thus, an entity can identify problems with badges.

The method 400 may be practiced where causing an indicator to be displayed in a trustworthy way to indicate to the user that the purported badge is compliant with the policy comprises displaying to a user a visual indication that either an individual badge is compliant with the policy or a group of badges is compliant with the policy. For example, a badge, or group of badges may be displayed with a green halo or some other indicator.

The method 400 may further include determining that one or more other badges identified by a user are not compliant with the policy based on the one or more other badges not complying with the policy identified by the user, and as a result causing information to be displayed indicating why the one or more other badges are not compliant with the policy.

The method 400 may further include determining that one or more other badges identified by a user are not compliant with the policy based on the one or more other badges not complying with the policy identified by the user, and as a result causing the one or more other badges to be displayed with a clear indicator of non-compliance with the policy. For example, a badge may be displayed with a red X through it, a red halo, or some other indicator.

The method 400 may be practiced where causing an indicator to be displayed in a trustworthy way to indicate to the user that the purported badge is compliant with the policy comprises causing an indicator to be projected or super imposed indicating compliance with the policy onto an already existing image of the badge. For example, as shown in FIG. 2 an indicator may be superimposed or projected onto an existing image.

The method 400 may be practiced where the trustworthy verifier is out-of-band with respect to an issuer of the badge. In particular, the trustworthy verifier and the issuer of a badge may be controlled by different enterprises or entities. Thus, an issuer is not directly verifying their own badges.

The method 400 may be practiced where the trustworthy verifier is selected to be a trustworthy verifier by voting of members of a federation. For example, different issuers, entities, individuals, etc. may vote and elect a trustworthy verifier. Thus, the trustworthy verifier is considered trusted by common consent of the entities trusting the trustworthy verifier.

The method 400 may be practiced where the trustworthy verifier is selected to be a trustworthy verifier by the trustworthy verifier being part of a well-known organization. For example, the trustworthy verifier may be controlled by a government agency or large and/or long established company.

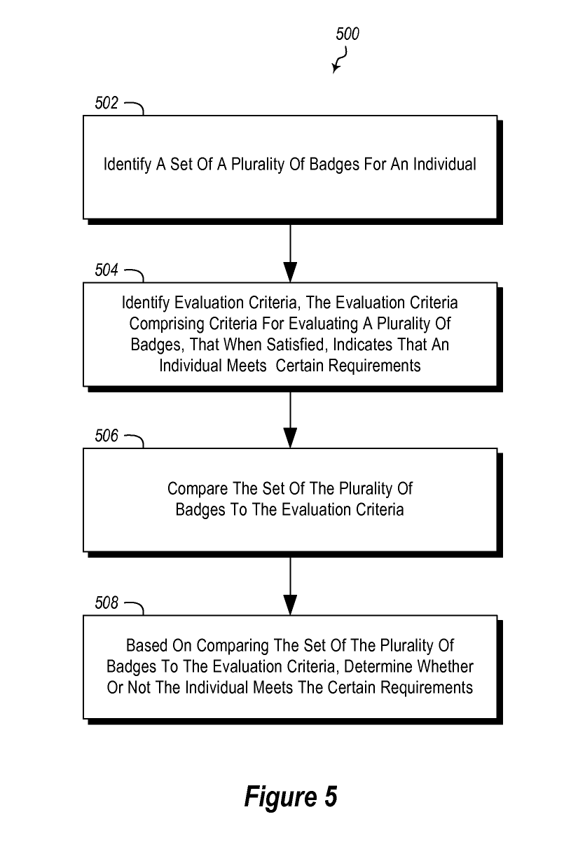

Referring now to FIG. 5, another method 500 is illustrated. The method 500 may be practiced in a computing environment. The method 500 includes acts for identifying that one or more badges in a set of a plurality of badges indicates that an individual having the set of a plurality of badges meets certain requirements in terms of one or more of skills, training, attributes, or qualifications. The method includes identifying a set of a plurality of badges for an individual (act 502). For example, a individuals badges in their backpack may be identified.

The method 500 further includes identifying evaluation criteria, the evaluation criteria comprising criteria for evaluating a plurality of badges, that when satisfied, indicates that an individual meets certain requirements (act 504). For example, the evaluation criteria may indicate a plurality of different sets of badges. This may be done by indicating different lists of individual badges; equivalent badges that may be substituted for one another in a list, or other indications. Each of the different sets includes one or more badges. If an individual has all badges in a given set from among the plurality of different sets of badges, then the individual meets the certain requirements. In some embodiments, the evaluation criteria is constructed based on members of a federation voting on the evaluation criteria. For example, members of a federation may vote to give some badges credence while similar badges are not given credence and thus not included in a set of badges that are accepted for determining if an individual meets certain requirements. For example, various social networking platforms allow individuals to be endorsed for certain skills or training. However, some of these are more generally regarded than others. By putting endorsements to a federation vote, a determination can be made regarding which endorsements are acceptable and which are not. In some embodiments, the evaluation criteria is constructed based on criteria identified by a well-established organization. For example, a well-respected organization or government organization may publish criteria that can be used for evaluation.

The evaluation criteria may include a number of different ways that an individual could meet the evaluation criteria. In particular, in some embodiments, there is not a specific set of badges that an individual must have, but rather, the individual may obtain a sufficient set of badges, where different sets of badges would all be equally sufficient. Although, the different sets of badges may have some overlapping badges that are common to two or more of the sets.

The method 500 further includes comparing the set of the plurality of badges to the evaluation criteria (act 506); and based on comparing the set of the plurality of badges to the evaluation criteria, determining whether or not the individual meets the certain requirements (act 508).

The method 500 may further include identifying one or more different sets of remaining badges, any set of which, if obtained by the individual, would cause the individual to meet the certain requirements and notifying the individual regarding the one or more different sets of remaining badges. For example, if an individual is lacking one or more badges for one or more of the identified sets, the individual could be notified of various alternative badges that the individual could earn to complete one or more of the sets so as to meet the evaluation criteria.

The method 500 may further include identifying one or more badges from the set of a plurality of badges for an individual that are about to expire, and notifying the individual regarding the one or more badges from the set of a plurality of badges for an individual that are about to expire.

The method 500 may further include determining that the individual meets the certain requirements in the evaluation criteria, and as a result, issuing the individual a super badge.

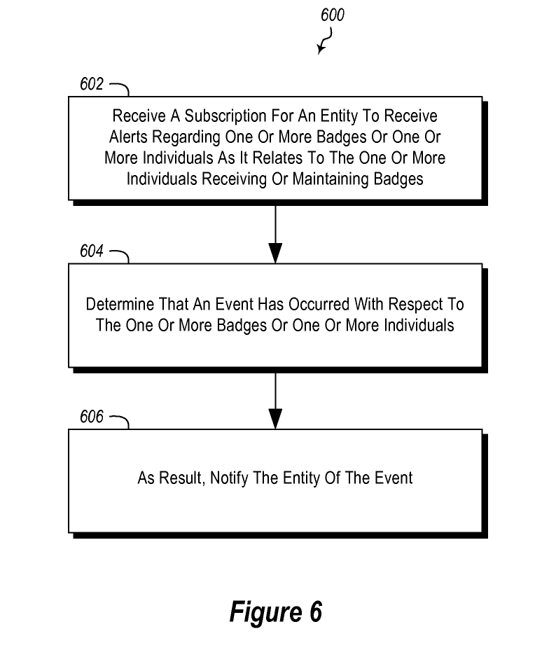

Referring now to FIG. 6, a method 600 is illustrated. The method 600 may be practiced in a computing environment and includes acts for sending alerts regarding events related to badges. The method includes receiving a subscription for an entity to receive alerts regarding one or more badges or one or more individuals as it relates to the one or more individuals receiving or maintaining badges (act 602). The one or more badges signify one or more of skills, training, attributes, or qualifications of individuals who receive them. For example, as illustrated in FIG. 3, entities may register with a subscription service 304 to receive alerts regarding badges.

The method 600 may further include determining that an event has occurred with respect to the one or more badges or one or more individuals (act 602); and as a result, notifying the entity of the event (act 604). For example, FIG. 3 illustrates sending metadata to the issuer 302. However, events may be sent in other embodiments to any of a number of different entities including other issuers, individuals who receive badges, verifiers, or other interested parties.

The method 600 may be performed where the acts are performed iteratively such that each time individuals earn a badge related to the certain skills, training, attributes, or qualifications or interest to the entity, the entity is notified.

The method 600 may be performed where the subscription specifies a desire to receive an alert when an individual has met certain requirements, and wherein if an individual has all badges in a given set from among a plurality of different sets of badges, then the individual meets the certain requirements, wherein each of the different sets of badges comprise one or more badges.

The method 600 may be performed where the event comprises identifying that one or more badges is about to expire. Alternatively or additionally, the method 600 may be performed where the event comprises identifying one or more badges that an individual could earn related to badges already obtained by the individual. Alternatively or additionally, the method 600 may be performed where the event comprises identifying one or more badges that an individual could earn to obtain a super badge based on badges already obtained by the individual.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of identifying that one or more badges in a set of a plurality of badges indicates that an individual having the set of a plurality of badges meets certain requirements in terms of one or more of skills, training, attributes, or qualifications the method comprising:
identifying a set of a plurality of badges for an individual;
identifying evaluation criteria, the evaluation criteria comprising criteria for evaluating a plurality of badges, that when satisfied, indicates that an individual meets certain requirements;
comparing the set of the plurality of badges to the evaluation criteria; and
based on comparing the set of the plurality of badges to the evaluation criteria, determining whether or not the individual meets the certain requirements.

2. The method of claim 1, wherein the evaluation criteria indicates a plurality of different sets of badges, each of the different sets comprising one or more badges, wherein if an individual has all badges in a given set from among the plurality of different sets of badges, then the individual meets the certain requirements.

3. The method of claim 1, further comprising identifying one or more different sets of remaining badges, any set of which, if obtained by the individual, would cause the individual to meet the certain requirements and notifying the individual regarding the one or more different sets of remaining badges.

4. The method of claim 1, further comprising identifying one or more badges from the set of a plurality of badges for an individual that are about to expire, and notifying the individual regarding the one or more badges from the set of a plurality of badges for an individual that are about to expire.

5. The method of claim 1, further comprising determining that the individual meets the certain requirements, and as a result, issuing the individual a super badge.

6. The method of claim 1, wherein the evaluation criteria is constructed based on members of a federation voting on the evaluation criteria.

7. The method of claim 1, wherein the evaluation criteria is constructed based on criteria identified by a well-established organization.

8. In a computing environment, a system for identifying that one or more badges in a set of a plurality of badges indicates that an individual having the set of a plurality of badges meets certain requirements in terms of one or more of skills, training, attributes, or qualifications the system comprising:
one or more processors; and
one or more computer readable media, wherein the one or more computer readable media comprise computer executable instructions that when executed by at least one of the one or more processors cause the system to perform the following:
identifying a set of a plurality of badges for an individual;
identifying evaluation criteria, the evaluation criteria comprising criteria for evaluating a plurality of badges, that when satisfied, indicates that an individual meets certain requirements;
comparing the set of the plurality of badges to the evaluation criteria; and
based on comparing the set of the plurality of badges to the evaluation criteria, determining whether or not the individual meets the certain requirements.

9. The system of claim 8, wherein the evaluation criteria indicates a plurality of different sets of badges, each of the different sets comprising one or more badges, wherein if an individual has all badges in a given set from among the plurality of different sets of badges, then the individual meets the certain requirements.

10. The system of claim 8, wherein the one or more computer readable media comprise computer executable instructions that when executed by at least one of the one or more processors cause the system to identify one or more different sets of remaining badges, any set of which, if obtained by the individual, would cause the individual to meet the certain requirements and notify the individual regarding the one or more different sets of remaining badges.

11. The system of claim 8, wherein the one or more computer readable media comprise computer executable instructions that when executed by at least one of the one or more processors cause the system to identify one or more badges from the set of a plurality of badges for an individual that are about to expire, and notify the individual regarding the one or more badges from the set of a plurality of badges for an individual that are about to expire.

12. The system of claim 8, wherein the one or more computer readable media comprise computer executable instructions that when executed by at least one of the one or more processors cause the system to determine that the individual meets the certain requirements, and as a result, issue the individual a super badge.

13. The system of claim 8, wherein the evaluation criteria is constructed based on members of a federation voting on the evaluation criteria.

14. The system of claim 8, wherein the evaluation criteria is constructed based on criteria identified by a well-established organization.

15. A physical computer readable storage medium comprising computer executable instructions that when executed by at least one or more processors causes the following to be performed:
identifying a set of a plurality of badges for an individual;
identifying evaluation criteria, the evaluation criteria comprising criteria for evaluating a plurality of badges, that when satisfied, indicates that an individual meets certain requirements, wherein the evaluation criteria comprises a plurality of different ways that the individual could meet the evaluation criteria;
comparing the set of the plurality of badges to the evaluation criteria; and
based on comparing the set of the plurality of badges to the evaluation criteria, determining whether or not the individual meets the certain requirements.

16. The computer readable storage medium of claim 15, wherein the evaluation criteria indicates a plurality of different sets of badges, each of the different sets comprising one or more badges, wherein if an individual has all badges in a given set from among the plurality of different sets of badges, then the individual meets the certain requirements.

17. The computer readable storage medium of claim 15, further comprising computer executable instructions that when executed by at least one or more processors causes identifying one or more different sets of remaining badges, any set of which, if obtained by the individual, would cause the individual to meet the certain requirements and notifying the individual regarding the one or more different sets of remaining badges.

18. The computer readable storage medium of claim 15, further comprising computer executable instructions that when executed by at least one or more processors causes identifying one or more badges from the set of a plurality of badges for an individual that are about to expire, and notifying the individual regarding the one or more badges from the set of a plurality of badges for an individual that are about to expire.

19. The computer readable storage medium of claim 15, further comprising computer executable instructions that when executed by at least one or more processors causes determining that the individual meets the certain requirements, and as a result, issuing the individual a super badge.

20. The computer readable storage medium of claim 15, wherein the evaluation criteria is constructed based on members of a federation voting on the evaluation criteria.
